(19) United States
(12) Patent Application Publication
(10) Pub. No.: US 2011/0247735 A1
(43) Pub. Date: Oct. 13, 2011

(54) COPPER ALLOY MATERIAL FOR ELECTRIC/ELECTRONIC PARTS AND METHOD OF PRODUCING THE SAME

(76) Inventors: Koji SATO, Tokyo (JP); Kiyoshige Hirose, Tokyo (JP); Hiroshi Kaneko, Tokyo (JP); Ryosuke Matsuo, Tokyo (JP)

(21) Appl. No.: 13/164,591

(22) Filed: Jun. 20, 2011

Related U.S. Application Data
(63) Continuation of application No. PCT/JP2009/071263, filed on Dec. 21, 2009.

(30) Foreign Application Priority Data
Dec. 19, 2008 (JP) 2008-324792

(51) Int. Cl. C22C 9/02; C22F 1/08; B82Y 99/00

(52) U.S. Cl. 148/684; 148/433; 977/932

(57) ABSTRACT

A copper alloy material for electric/electronic parts, containing: Sn 3.0 to 13.0 mass %, any one or both of Fe and Ni 0.01 to 2.0 mass % in total, and P 0.01 to 1.0 mass %, with the balance being Cu and unavoidable impurities, wherein an average diameter of grains is 1.0 to 5.0 μm, wherein a compound X having an average diameter of 30 nm or more and 300 nm or less is dispersed in density 10⁴ to 10⁸ per mm², wherein a compound Y having an average diameter of more than 0.3 μm and not more than 5.0 μm is dispersed in density 10² to 10⁶ per mm²; and wherein a tensile strength is 600 MPa or more.

### TECHNICAL FIELD

The present invention relates to a copper alloy material for electric/electronic parts, which is favorable for the use in electric/electronic parts, such as terminals and connectors, and relates to a method of producing the same.

### BACKGROUND ART

Copper alloys, such as phosphor bronze (e.g. JIS C5210, JIS C5191) and brass (JIS C2600), have excellent workability and mechanical strength, and they are used in electric/electronic parts, such as connectors and terminals, for the use in electronic equipments or internal wiring of automobiles.

In recent years, while steady progress is made in the size reduction, weight reduction, and high density packaging of electronic equipments, there is a strong demand for metallic materials for electric/electronic parts having high mechanical strength and excellent bending property. These electric/electronic parts are generally subjected to punching with a high-speed press apparatus using a mold. Upon this punching, the material is subjected to shear deformation by the punch of the mold, cracks are generated in the inside of the material, which start from the site of the material that is brought into contact with the cutting edge of the punch, and thereby fracture deformation occurs, causing the material to be punched out into a predetermined shape.

However, as the number of shots in the punching using a press apparatus increases, frictional wear progresses in the cutting edge of the punch of the mold, and as a result, the crack generation from the site in contact with the cutting edge occurs non-uniformly, further causing the fracture shapes of electric/electronic parts to be in disorder. Specifically, the difference in level of the shear zone and the fracture zone may increase, or large burrs may occur, or large foreign matters of the material caused by fracture may occur, and even any of these will cause a punched electric/electronic part to be incapable of maintaining a predetermined shape. Thus, there is a demand for a copper alloy material having excellent punching property, which is intended for a reduction in the frictional wear of a mold or in the frequency of maintenance, as a material for electric/electronic parts.

However, although the mechanical strength (tensile strength) of a copper alloy material can be readily increased by work hardening, a work hardened material is generally poor in toughness, and there is a problem that bending cracks may occur upon the material is worked into a terminal or the like. In order to solve this problem, it is known to enhance the bending property of a copper alloy material, by adding iron (Fe), nickel (Ni), and phosphorus (P) to copper (Cu) to thereby disperse a compound of a second phase, and further by controlling the heat treatment conditions before the final-cold working to thereby make grains fine (see Patent Literature 1). Further, in regard to an improvement in the punching property of a copper alloy material, it is known to improve the pressing property, by adding elements, such as lead (Pb), bismuth (Bi), calcium (Ca), strontium (Sr), barium (Ba), and tellurium (Te), to phosphor bronze (Cu—Sn—P-based alloy), and thereby dispersing a compound of a second phase (see Patent Literature 2). Furthermore, as a technique of enhancing each of the mechanical strength, the bending property, and the stress relaxation resistance of a copper alloy material, there is known a Cu—Sn-based alloy having a precipitate which has a diameter of 1 to 50 nm and a density of 10⁶ to 10¹⁰ per mm², and a precipitate having a diameter of 50 to 500 nm and a density of 10⁴ to 10⁸ per mm² (see Patent Literature 3).

### CITATION LIST

### Patent Literatures

Patent Literature 1: International publication No. WO 2002/053790 pamphlet
Patent Literature 2: JP-A-10-195562 (“JP-A” means unexamined published Japanese patent application)
Patent Literature 3: JP-A-2006-274445

### SUMMARY OF INVENTION

### Technical Problem

The inventions described in Patent Literatures 1 to 3, however, still do not exhibit satisfactory characteristics in each of mechanical strength (tensile strength), bending property, and punching property. The inventors of the present invention, having studied keenly on phosphor bronze-based materials that have been widely used heretofore, have found that the punching property can be improved while maintaining the mechanical strength (tensile strength) and the bending property, and have further proceeded with investigation, to complete the present invention.

Thus, the present invention is contemplated for providing a copper alloy material that is excellent in various characteristics (in particular, tensile strength, bending property, and punching property) required in electric/electronic parts, such as terminals for connectors.

### Solution to Problem

One feature of the copper alloy material of the present invention is to contain a compound having a smaller diameter (hereinafter, compound X), which makes grains in the copper alloy fine, and a compound having a larger diameter (hereinafter, compound Y), which improves the punching property, respectively, in appropriate amounts. Further, these two kinds of compounds different in size can be formed by subjecting the copper alloy material to a specific process. That is, according to the present invention, there is provided the following means:
[1] A copper alloy material for electric/electronic parts, comprising: Sn 3.0 to 13.0 mass %, any one or both of Fe and Ni 0.01 to 2.0 mass % in total, and P 0.01 to 1.0 mass %, with the balance being Cu and unavoidable impurities, wherein an average diameter of grains is 1.0 to 5.0 μm, wherein a compound X having an average diameter of 30 nm or more and 300 nm or less is dispersed in a density of 10⁴ to 10⁸ per mm², wherein a compound Y having an average diameter of more than 0.3 μm and not more than 5.0 μm is dispersed in a density of 10² to 10⁶ per mm²; and wherein a tensile strength is 600 MPa or more;
[2] A copper alloy material for electric/electronic parts, comprising: Sn 3.0 to 13.0 mass %, any one or both of Fe and Ni 0.01 to 2.0 mass % in total, at least one of Co, Cr, and Mn 0.01 to 1.0 mass % in total, and P 0.01 to 1.0 mass %, with the balance being Cu and unavoidable impurities, wherein an average diameter of grains is 1.0 to 5.0 μm, wherein a compound X having an average diameter of 30 nm or more and 300 nm or less is dispersed in a density of 10⁴ to 10⁸ per mm², wherein a compound Y having an average diameter of more than 0.3 μm and not more than 5.0 μm is dispersed in a density of 10² to 10⁶ per mm²; and wherein a tensile strength is 600 MPa or more;
[³] The copper alloy material for electric/electronic parts described in the above item [1] or [2], wherein an average value of the average diameter of the compound X is 50 nm or more and 200 nm or less;
[4] The copper alloy material for electric/electronic parts described in the above item [1] or [2], wherein an average value of the average diameter of the compound Y is 0.5 μm or more and 3.0 μm or less;
[5] The copper alloy material for electric/electronic parts described in any one of the above items [1] to [4], wherein the compound Y has a ratio expressed by: {(the density of compound Y in a region up to 10% in thickness from a surface layer)/(the density of compound Y in a region from 40% to 60% in thickness from the surface layer)}, of 0.8 to 1.0;
[6] A method of producing the copper alloy material for electric/electronic parts described in any one of the above items [1] to [5], comprising: subjecting an ingot to a homogenization treatment, with the ingot having been produced under the conditions in which a cooling speed at the time of casting is higher than 1° C./sec and lower than 100° C./sec; face milling of the surface in a thickness of 1 mm or more; repeating cold rolling and intermediate annealing; and conducting finish rolling and strain relief annealing;
[7] The method of producing the copper alloy material for electric/electronic parts described in the above item [6], wherein a final intermediate annealing immediately before the finish rolling is conducted at 300 to 550° C.

The copper alloy material for electric/electronic parts of the present invention has a high mechanical strength such that the tensile strength (TS) is 600 MPa or more, preferably 700 MPa or more. The upper limit of this tensile strength is not particularly limited, but is preferably 800 MPa or less, from the viewpoint of regarding the bending characteristics (bending property) as important.

### Advantageous Effects of Invention

The copper alloy material of the present invention can have improved punching property without impairing the mechanical strength (tensile strength) and the bending property, so that the characteristics can be obtained at a high level required of a copper alloy for electric/electronic parts, for example, for use in terminals and connectors.

Other and further features and advantages of the invention will appear more fully from the following description, appropriately referring to the accompanying drawing.

### BRIEF DESCRIPTION OF DRAWING

FIG. 1 is a graph showing the conditions for a homogenization heat treatment with preferable temperatures and time periods, and the area surrounded by a trapezoidal shape in the diagram represents preferable ranges of the conditions for the homogenization heat treatment.

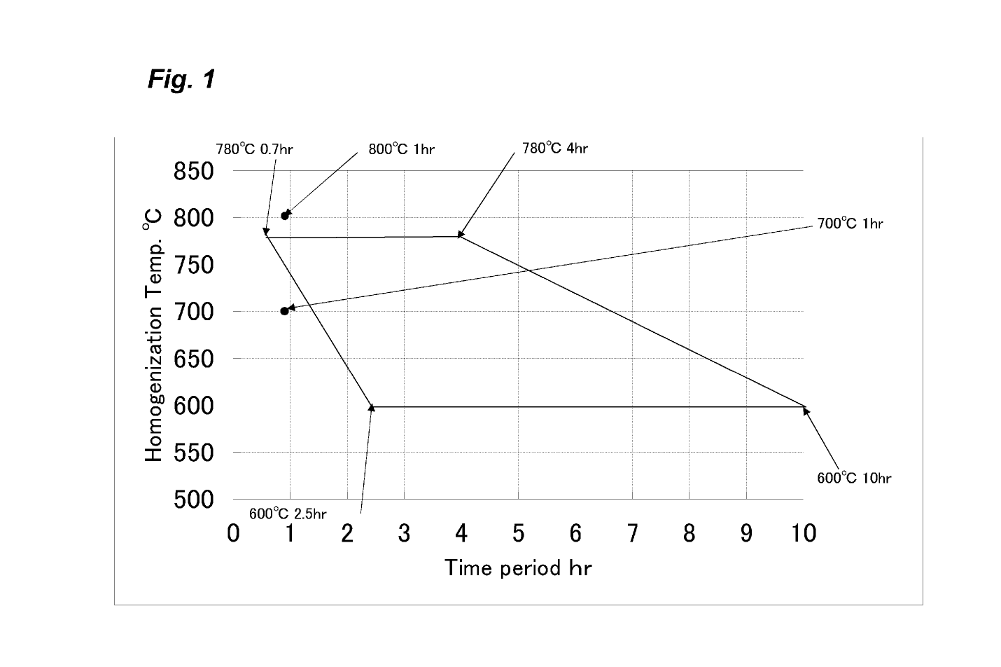

### DESCRIPTION OF EMBODIMENTS

Hereinafter, a preferable embodiment of the present invention will be described. In the following description, a sheet material in particular will be explained as a copper alloy material. The shape of the copper alloy material of the present invention is preferably a sheet shape (sheet material, strip material, or the like) under the presumption that the copper alloy material is subjected to punching.

In the copper alloy material of the present invention, at least one element of iron (Fe) or nickel (Ni), and phosphorus (P) are contained in the copper alloy, and thereby the resultant copper alloy material has a compound that is composed of these additive elements (specifically, Fe—P, Ni—P, and Fe—Ni—P). In the present invention, these compounds are defined by classifying them into a fine compound X (having a diameter of 30 nm or more and 300 nm or less) and a compound Y which is larger than the compound X (having a diameter of more than 0.3 μm and not more than 5.0 μm). The diameter (average diameter) and density of a compound are values obtained, by taking photographs of the cross-section in the direction parallel to the rolling direction using a transmission electron microscope, and measuring the diameter (average value of the major axis and the minor axis) and the density of the compound on the photographs.

The reason for defining the average diameter of the compound X in the copper alloy to be in the range of 30 nm or more and 300 nm or less, is to make grains fine. When the particles are smaller than this range, the grain boundary cannot be pinned, and the effect of making the grains fine cannot be obtained. On the other hand, when the particles are larger than this range, the effects of pinning of the grain boundary and resultantly making of the grains fine are small. The average diameter of the compound X is preferably 50 nm or more and 200 nm or less. Furthermore, the average value of the average diameter of the compound X is preferably 50 nm or more and 200 nm or less. In the present invention, a compound having an average diameter of less than 30 nm has almost no adverse effect per se on the punching property and bending property, but if the density of such a compound increases too much, the density of the compound X or compound Y lowers. Therefore, it is preferable that the density of a compound having an average diameter of less than 30 nm be as low as possible.

The density of the compound X is set to 10⁴ to 10⁸ per mm² because the grains can be produced stably. If the density of the compound X is too low, the growth of the grains cannot be controlled, and the grains become coarse. If the density of the compound X is too high, the diameter of the compound becomes small so that the growth of the grains cannot be controlled, and the grains become coarse. The density of the compound X is preferably 10⁵ to 10⁸ per mm², and more preferably 10⁶ to 10⁸ per mm².

The average diameter of the compound Y is defined to be more than 0.3 μm and not more than 5.0 μm, because the punching property is improved thereby. Particles larger than this range generate stress concentration upon bending, and there occurs a problem of bending cracks which start from these sites as the starting points. On the other hand, particles smaller than this range are small in the effect of improving punching property. Further, if the amount of a compound that is smaller than the compound Y is too large, the density of the compound Y is lowered. The average diameter of the compound Y is preferably 0.5 μm or more and 3.0 μm or less. Furthermore, the average value of the average diameter of the compound Y is preferably 0.5 μm or more and 3.0 μm or less, and more preferably 0.6 μm or more and 3.0 μm or less.

The density of the compound Y is defined to be 10² to 10⁶ per mm² because the punching property is improved thereby. If the density of the compound Y is too low, the density of the compound Y which should serve as the starting point of fracture cracks at the time of punching is low, and as a result the punching property cannot be improved. If the density of the compound Y is too high, the diameter of the compound becomes small so that the growth of the grains cannot be controlled, and the grains become coarse. Furthermore, the bending property becomes poor. The density of the compound Y is preferably 10³ to 10⁵ per mm².

The copper alloy material of the present invention contains tin (Sn), phosphorus (P), and iron (Fe) and/or nickel (Ni), and optionally other additive element(s), with the balance being copper (Cu) and unavoidable impurities.

In the copper alloy material of the present invention, the reason for specifying the content of Sn to 3.0 to 13.0 mass % is that the mechanical strength (tensile strength) can be improved. When the Sn content is too low, the mechanical strength obtained by solution strengthening is not sufficient. In contrast, when the Sn content is too high, an extremely brittle Cu—Sn intermetallic compound is formed to thereby make the workability poor, which is a problem. The content of Sn is preferably 5.0 to 11.0 mass %, and more preferably 7.0 to 11.0 mass %.

The amounts of Fe and Ni contained in the copper alloy material of the present invention are each preferably 0.01 to 1.0 mass %, and the total amount of any one or both kinds of these elements is 0.01 to 2.0 mass %. The content of Fe is preferably 0.05 to 0.5 mass %. The content of Ni is preferably 0.02 to 0.4 mass %. The total content of any one or both kinds of Fe and Ni is preferably 0.05 to 0.5 mass %. Further, the copper alloy material of the present invention contains P in an amount of 0.01 to 1.0 mass %, and more preferably 0.03 to 0.30 mass %. When the copper alloy material of the present invention contains Fe and/or Ni and P in their respective predetermined amounts, the grain diameter does not become coarse, and no cracks occur upon rolling.

Furthermore, when the amount of (Fe+Ni) in the compound that constitutes the compound Y is 68 to 88 mass %, and the amount of P therein is 10 to 25 mass %, the particles which exhibit effectiveness in press punchability can be stably dispersed, and the punching property can be enhanced. In addition, there are occasions in which the sum of the above-mentioned contents does not add up to 100 mass %, and it is because the compound Y may contain other element(s) (for example, Cu or Sn).

The copper alloy material of the present invention may contain at least one selected from cobalt (Co), chromium (Cr), and manganese (Mn). These Co, Cr, and Mn crystallize or precipitate out as a second phase (compound) with phosphorus (P), and are effective in the control of the grain diameter and in enhancement of the punching property. In the case of adding any of these elements, the total content of one kind or two or more kinds of Co, Cr, and Mn is set to 0.01 to 1.0 mass %. This is because, if the total content is too small, the effect of addition of these elements is not sufficiently obtained, and if the total content is too large, a coarse compound crystallizes out upon casting, causing poor bending property.

In the present invention, the reason for specifying the average diameter of grains of the copper alloy material (average grain diameter) to 1.0 to 5.0 μm is that excellent mechanical strength (tensile strength) and excellent bending property can be attained. When the diameter is too small, degradation of ductility is more remarkable than improvement in mechanical strength (tensile strength), resulting in the deterioration in the toughness; thus the bending property becomes poor. Further, there is a problem that such a copper alloy cannot be stably produced industrially. When the diameter is too large, the mechanical strength (tensile strength) attained by making grains fine is insufficient, which is a problem. The diameter is preferably 1.0 to 2.0 μm.

When the density of the compound Y is uniform in the direction of the sheet thickness, the punching property can be further enhanced. Thus, it is preferable for the compound Y that the ratio expressed by: {(the density of compound Y in a region up to 10% in thickness from the sheet surface layer)/(the density of compound Y in a region from 40% to 60% in thickness from the sheet surface layer)}, is 0.8 to 1.0.

In regard to the deformation of a material at the time of pressing, it is believed that a deformation develops from the surface layer to cause cracks, which lead to fracture. Accordingly, when the amount of a crystallization product (compound Y) that is likely to serve as the starting points of cracks in the surface layer is small, the resultant material is not very likely to undergo fracture, causing deterioration of the service life of the mold. Generally, in the surface layer, a cooling speed is fast at the time of casting, to yield a small amount of the crystallization product. On the other hand, when a too large amount of crystallization product is present in the surface layer, hard crystallization product is brought into contact with the mold, and the mold is abraded. This is believed to occur because segregation of a compound occurs to a large extent in the outermost portion of the surface layer.

On the contrary, in the copper alloy material of the present invention, such segregation does not readily occur, and therefore, the copper alloy material can exhibit favorable punchability.

In the method of producing the copper alloy material of the present invention, an ingot produced under the conditions in which the cooling speed at the time of casting is higher than 1° C./sec and lower than 100° C./sec, is subjected to a homogenization treatment, followed by face milling both of the front and rear surfaces in a total thickness of 1 mm or more, repeating cold rolling and intermediate annealing 2 to 4 times, and subjecting to finish rolling and strain relief annealing. In this manner, a recrystallized texture whose grain diameter is 1 to 5 μm can be stably produced industrially, and it is possible to prevent variation/fluctuation in the worked texture and particle diameter in the recrystallized texture to be obtained. Furthermore, when the cooling speed of the casting is specified, the amount of crystallization product can be controlled, and the amount of dispersion of the compound Y can be controlled in a given value. Also, by performing face milling of the surface in a thickness of 1 mm or more, and repeating cold rolling and intermediate annealing, the fluctuation in the density of the compound Y in the sheet thickness direction can be suppressed.

In the production method of the present invention, the rolling is conducted by cold rolling, and hot rolling is not utilized. This is because when the copper alloy material of the present invention is subjected to hot working (hot rolling), the material may have working cracks. Furthermore, by repeating cold rolling and intermediate annealing, the resultant copper alloy material can be prevented from becoming too hard, and when the copper alloy material is thinned to a predetermined thickness, the copper alloy material can be prevented from becoming too hard and thereby suffering working cracks.

An example of a preferred embodiment of the method of producing the copper alloy of the present invention includes the following steps.

An alloy composed of Sn, P, and other additive element(s), with the balance being Cu, is melted using, for example, a high-frequency melting furnace, and is cast under the conditions in which the cooling speed at the time of casting is faster than 1° C./sec and slower than 100° C./sec, to obtain an ingot. This ingot is subjected to a homogenization heat treatment at 850° C. to 600° C. for 0.5 hours to 10 hours, and more preferably to a homogenization heat treatment under the conditions of temperature and time period in which the relationship between time period and temperature is surrounded by straight lines that connect the four points of (780° C., 0.7 hours), (780° C., 4 hours), (600° C., 10 hours), and (600° C., 2.5 hours). The conditions of homogenization heat treatment with such preferable temperature and time period are shown in FIG. 4. The area surrounded by a trapezoid in FIG. 4 represents the preferred range of the conditions for homogenization heat treatment. It is preferable that the homogenization heat treatment be conducted in a relatively short period of time in the case of a high temperature, and be conducted in a relatively long period of time in the case of a low temperature. Furthermore, if the homogenization heat treatment temperature is too high, the crystallization product generated by casting form a solid solution, and as a result, the amount of the compound Y that contributes to enhancement of the punching property is decreased. Even in the case where the temperature of the homogenization heat treatment is low, when the material is heat treated for a long time period, the compound becomes coarse, and the number of compounds Y decreases, which is not preferable. It is particularly preferable to precisely control the temperature of the homogenization treatment. After the homogenization heat treatment, the material is slowly cooled, and the surface is face milled in a thickness of 1 mm or more. This face milled amount is preferably 2 mm or more. There are no particular limitations on the upper limit of the face milled amount, but the face milled amount of 5 mm or less is generally employed. Then, the thus face-milled material is subjected to cold rolling a at a ratio of 40% to 70%, followed by a heat treatment a at 550 to 750° C. for 1 to 10 hours in an inert gas atmosphere, and slow cooling. The thus cooled material is further subjected to cold rolling b at a rolling ratio of 40% to 80%, followed by a heat treatment b at 350 to 550° C. for 1 to 10 hours in an inert gas atmosphere, to obtain a texture having an average grain diameter of 5 to 20 μm.

The resultant material, which has been subjected to the heat treatment b, is subjected to a cold-rolling c at a working ratio of 40 to 80%, followed by subjecting to a heat treatment c at 300 to 550° C. for 10 to 120 seconds, to obtain a recrystallized texture. Then, a cold-rolling d is conducted at a working ratio of 40 to 70%, followed by a heat treatment d at 300 to 550° C. for 5 to 200 seconds. In the heat treatment d, it is preferable to set a heating speed and a cooling speed, respectively, to 5° C./sec to 80° C./sec, more preferably about 40° C./sec. The driving force for recrystallization in the heat treatment d is stored by the cold-rolling d, and a texture with a grain diameter of 1 to 5 μm is obtained at the end of the heat treatment d.

The compound X is mainly formed in the heat treatment c and the heat treatment d. On the other hand, the compound Y is mainly formed in the casting, the homogenization heat treatment, the heat treatment a, and the heat treatment b. Furthermore, after the step of heat treatment d, the compound X and the compound Y are in a uniformly dispersed state. In order to obtain a uniform recrystallized texture after the step of heat treatment c, it is preferable to conduct the cold-working b between the heat treatment a and the heat treatment b at a working ratio of 40 to 80%, preferably 50 to 70%. When the working ratio is too high, working cracks occur. When the working ratio is too low, recrystallization is not completed in the heat treatment b, and therefore working cracks occur by a cold-working after the heat treatment b, which is a problem.

After the heat treatment d, the resultant material is subjected to a final cold rolling at a working ratio of 10% to 30%, followed by a strain relief heat treatment at 150° C. to 250° C. for 0.2 hours to 1.0 hours, preferably for about 0.5 hours.

Among the alloy production conditions described above, the factors that can control the grain diameter, the sizes of compound X and compound Y, and the density of formation, as defined in the present invention, are, for example, the conditions of casting, and the conditions in the homogenization heat treatment, the heat treatments (a, b, c, and d), and the cold rollings (a, b, c, and d), in addition to the alloy composition. When these conditions are specified as described above, a target copper alloy material can be obtained. However, the cold rolling b and the heat treatment b, or the cold rolling d and the heat treatment d are steps that are optionally conducted, and can be omitted. When the working ratio of each rolling is 40% or more, coarse compound is crushed upon rolling, and thereby the density of the compound Y can be increased.

The copper alloy material of the present invention can be favorably used in electric/electronic parts, for example, a connector, a terminal, a relay, a switch, and a lead frame.

### EXAMPLES

The present invention will be described in more detail based on examples given below, but the invention is not meant to be limited by these.

Alloys of Examples (working examples according to the present invention, Ex) were produced as follows. Each alloy, containing Sn in the respective amount as shown in each Example, P in an amount of 0.07 mass %, and other additive element(s), with the balance of Cu, was dissolved in a high-frequency melting furnace, followed by DC (direct chill) casting under the conditions at a cooling speed at the time of casting of higher than 1° C./sec and lower than 100° C./sec, to give a respective ingot with thickness 30 mm, width 100 mm, and length 150 mm.

The thus-obtained respective ingot was subjected to homogenization heat treatment at 800° C. for 1 hour, followed by slow cooling, and face milling of the both surfaces in thickness 2 mm or more each, to remove an oxide layer. Then, cold-rolling a at a working ratio of 40 to 70% was conducted, followed by heat treatment a at 550 to 750° C. for 1 to 10 hours in an inert gas atmosphere, and slow cooling. Further, cold-rolling b at a rolling ratio of 40% to 80% was conducted, to form a sheet material with thickness 2 to 5 mm, followed by heat treatment b at 350 to 550° C. for 1 to 10 hours in an inert gas atmosphere, to give a texture with an average grain diameter of 5 to 20 μm.

The resultant material, which had been subjected to the heat treatment b, was subjected to cold-rolling c at a working ratio of 40 to 80%, followed by heat treatment c at 300 to 550° C. for 10 to 120 seconds. The resultant sheet material having a texture with an average grain diameter of 1 to 15 μm, which had been subjected to the heat treatment c, was subjected to cold-rolling d at a working ratio of 40 to 70%, followed by heat treatment d at 300 to 550° C. for 5 to 200 seconds. The heat treatment d was conducted at a heating speed and a cooling speed of 40° C./sec, respectively. Then, final cold-rolling at a working ratio of 10 to 20% was conducted, followed by strain relief heat treatment at 150 to 250° C. for 0.5 hours, to obtain a sheet material with thickness 0.2 mm. Furthermore, Comparative examples 8 and 9 are comparative test examples of examining the effects obtained when the condition of the cooling speed for the casting was changed. Comparative examples 8 and 9 were conducted in the same manner as in Examples described above, except that Comparative example 8 was conducted at a cooling speed for casting of 120° C./sec, and Comparative example 9 was conducted at a cooling speed for casting of 0.5° C./sec, respectively.

The thus-obtained sheet materials (samples) each were evaluated on the following properties. The results are shown in the following table. The measurement methods of the respective evaluation are described below.

a. Mechanical Properties (Tensile Strength; TS)

Three test specimens (JIS-13B) that were cut out from the respective sample in the direction parallel to the rolling direction, were measured according to JIS-Z2241, to determine the average value (MPa).

b. Bending Property (BP)

A test specimen was cut out from the respective sample (sheet material) into a size of width 10 mm and length 25 mm. The resultant test specimen was W-bent at a bending angle 90° with a bending radius R that would be 0 (zero). Whether cracks were occurred or not at the bent portion, was observed with the naked eye through observation with an optical microscope with a magnification of 50×, to examine whether cracks were observed or not at the bent portion. The respective test specimen was cut out from the sample such that it would be W-bent such that the axis of bending was perpendicular to the rolling direction, which is designated as G. W. (Good Way), and separately W-bent such that the axis of bending was parallel to the rolling direction, which is designated as B. W. (Bad Way). According to the results, a sample which did not have any crack occurred at the bent portion was judged to be “∘” (good), and a sample which had cracks occurred was judged to be “×” (poor).

c. Average Grain Diameter (GS)

In a cross section parallel to the thickness direction of the sample (sheet material) and also parallel to the final cold-rolling direction (the final plastic-working direction), the grain diameters were measured in the two directions: the direction parallel to the final cold-rolling direction and the direction perpendicular to the final cold-rolling direction. The larger measured values were classified as major diameters and the smaller measured values were classified as minor diameters. The average value of the respective four values of the major diameters and the minor diameters was shown. The measurement was made in the following manner. According to the cutting method (JIS-H0501), etching was performed after the cross section of the sample was mirror-ground. The thus-ground sample was photographed with a scanning electron microscope (SEM) with a magnification of 1,000×, and a line segment with length 200 mm was drawn on the resultant photograph. Then, the number n of grains cut with the line segment was counted, to determine an average grain diameter from the formula: 200 mm/(n×1,000). In the case where the thus-obtained number of grains cut with the 200 mm line segment was less than 20, the grains were separately photographed with a magnification of 500×, and, the number n of grains cut with the line segment with length 200 mm was counted, to determine an average grain diameter from the formula: 200 mm/(n×500).

d. Size and Density of Second Phase Compounds (Compound X and Compound Y)

A sample was punched to have a diameter of 3 mm, followed by polishing such that the region from 40% to 60% in the sheet thickness from the sheet surface layer would be turned into a thin film by using a twin-jet polishing method. Photographs (with a magnification of 1,000× to 100,000×) of the resultant sample were taken at 3 arbitrary positions with a transmission electron microscope with accelerating voltage 300 kV, and the grain size and the density of the respective compound were measured on the photographs. In regard to the grain size, the respective average values, for the range of the grain size of compound X and the range of the grain size of compound Y, are indicated in the table as an integral multiple of 0.005 mm. When measurement of the grain size and the density of the compound were carried out, the number of grains was measured at n=10 (n represents the number of viewing fields for observation), thereby to eliminate the localized bias on the numbers. The number was calculated into the number per unit area (/mm²).

e. Press-Punching Property

After polishing the mold, each sample was subjected to continuous pressing at a speed of 500 times per minute, in a punching shape of a square having a size of 3 mm×5 mm. Pressing was stopped when the mold was abraded, and burrs exceeding 10 μm in size were occurred on the press-fractured surface of the material, and the number of shots made to that time point was measured. This measurement was made 3 times, and the results are classified into the following criteria. That is, a sample which gave a minimum value of the number of shots of 3 million times or more, was judged to have a particularly excellent punchability, and is indicated in the table as “ [symbol] .” A sample which gave a minimum value of the number of shots of 2 million times or more, was judged to have a satisfactory punchability, and is indicated in the table as “∘.” A sample which gave an average value of the number of shots of 2 million times or more, was judged to have a satisfactory punchability, but which gave a minimum value of the number of shots of less than 2 million times, caused fluctuations, is indicated in the table as “Δ.” A sample which gave an average value of the number of shots of less than 2 million times, was judged to have a poor punchability, and is indicated in the table as “×.” These evaluation results are shown as “Punchability (1)” in the following table.

The results of Examples 1 to 18 (working examples according to the present invention, Ex) and Comparative examples 1 to 12 (Comparative examples, CE) are shown in Table 1.

TABLE 1

| | Elements (mass %) | | | | | Compound X1 | | Compound X2 | | Compound Y1 | |
|---|---|---|---|---|---|---|---|---|---|---|---|
| | | | | | Other | Size | Density | Size | Density | Size | Density |
| | Sn | Fe | Ni | P | element | (nm) | (/mm²) | (nm) | (/mm²) | (cm) | (/mm²) |
| Ex 1 | 3 | 0.21 | 0.081 | 0.07 | — | 105 | 1.0 × 10⁶ | 95 | 0.9 × 10⁶ | 600 | 1.0 × 10⁴ |
| Ex 2 | 5.2 | 0.23 | 0.079 | 0.07 | — | 110 | 1.0 × 10⁶ | 105 | 0.9 × 10⁶ | 600 | 1.0 × 10⁴ |
| Ex 3 | 7.3 | 0.25 | 0.076 | 0.07 | — | 110 | 1.0 × 10⁶ | 105 | 0.9 × 10⁶ | 600 | 1.0 × 10⁴ |
| Ex 4 | 9.2 | 0.23 | 0.072 | 0.07 | — | 100 | 1.0 × 10⁶ | 95 | 0.9 × 10⁶ | 600 | 1.0 × 10⁴ |
| Ex 5 | 9.1 | 0.5 | — | 0.07 | — | 105 | 1.0 × 10⁶ | 100 | 0.9 × 10⁶ | 650 | 1.0 × 10⁴ |
| Ex 6 | 9.3 | — | 0.8 | 0.07 | — | 130 | 1.0 × 10⁶ | 120 | 0.9 × 10⁶ | 700 | 1.0 × 10⁴ |
| Ex 7 | 9.3 | 0.007 | 0.004 | 0.07 | — | 70 | 1.0 × 10⁴ | 70 | 0.9 × 10⁴ | 320 | 1.0 × 10² |
| Ex 8 | 9.1 | 1.48 | 0.44 | 0.07 | — | 190 | 1.0 × 10⁷ | 180 | 0.9 × 10⁷ | 1700 | 1.0 × 10⁶ |
| Ex 9 | 9.2 | 0.21 | 0.076 | 0.01 | — | 110 | 1.0 × 10⁴ | 105 | 0.8 × 10⁴ | 600 | 1.0 × 10³ |
| Ex 10 | 8.9 | 0.18 | 0.041 | 0.1 | — | 100 | 1.0 × 10⁶ | 100 | 0.9 × 10⁶ | 600 | 1.0 × 10⁴ |
| Ex 11 | 10.9 | 0.25 | 0.085 | 0.07 | — | 120 | 1.0 × 10⁶ | 105 | 0.9 × 10⁶ | 600 | 1.0 × 10⁴ |
| Ex 12 | 12.9 | 0.31 | 0.082 | 0.08 | — | 125 | 1.0 × 10⁶ | 110 | 0.8 × 10⁶ | 600 | 1.0 × 10⁴ |
| Ex 13 | 9.2 | 0.23 | 0.072 | 0.07 | Co: 0.2 | 110 | 1.0 × 10⁷ | 105 | 0.9 × 10⁷ | 600 | 1.0 × 10⁵ |
| Ex 14 | 9.2 | 0.23 | 0.072 | 0.07 | Cr: 0.1 | 105 | 1.0 × 10⁷ | 100 | 0.9 × 10⁷ | 600 | 1.0 × 10⁵ |
| Ex 15 | 9.2 | 0.23 | 0.072 | 0.07 | Mn: 0.2 | 110 | 1.0 × 10⁷ | 110 | 0.9 × 10⁷ | 600 | 1.0 × 10⁵ |
| Ex 16 | 9.2 | 0.23 | 0.072 | 0.07 | Co: 0.1, | 115 | 1.0 × 10⁷ | 110 | 0.8 × 10⁷ | 600 | 1.0 × 10⁵ |
| | | | | | Cr: 0.1 | | | | | | |
| Ex 17 | 9.2 | 0.23 | 0.072 | 0.9 | — | 130 | 1.0 × 10⁷ | 120 | 0.9 × 10⁷ | 600 | 1.0 × 10⁴ |
| Ex 18 | 9.2 | 1.1 | 0.8 | 0.07 | — | 130 | 1.0 × 10⁴ | 120 | 0.9 × 10⁴ | 3100 | 1.0 × 10⁴ |
| CE 1 | 2.5 | 0.21 | 0.04 | 0.06 | — | 110 | 1.0 × 10⁶ | 105 | 0.9 × 10⁶ | 600 | 1.0 × 10⁴ |
| CE 2 | 9 | — | — | 0.07 | — | — | — | — | — | — | — |
| CE 3 | 9.2 | 1.9 | 0.4 | 0.07 | — | 230 | 1.0 × 10⁷ | 220 | 0.9 × 10⁷ | 800 | 1.0 × 10⁷ |
| CE 4 | 9.3 | 2.5 | — | 0.07 | — | 205 | 1.0 × 10⁷ | 200 | 0.9 × 10⁷ | 1200 | 1.0 × 10⁷ |
| CE 5 | 9.1 | — | 2.3 | 0.07 | — | 200 | 1.0 × 10⁴ | 195 | 0.9 × 10⁴ | 900 | 1.0 × 10⁷ |
| CE 6 | 9 | 0.004 | 0.003 | 0.07 | — | 60 | 1.0 × 10³ | 55 | 0.9 × 10³ | 350 | 1.0 × 10 |
| CE 7 | 13.7 | 0.21 | 0.04 | 0.06 | — | 120 | 1.0 × 10⁶ | 115 | 0.9 × 10⁶ | 600 | 1.0 × 10⁵ |
| CE 8 | 9.2 | 0.23 | 0.072 | 0.07 | — | 70 | 1.0 × 10⁷ | 65 | 0.9 × 10⁷ | 350 | 1.0 × 10 |
| CE 9 | 9.1 | 0.5 | — | 0.07 | — | 230 | 1.0 × 10³ | 220 | 0.9 × 10³ | 1000 | 1.0 × 10⁶ |
| CE 10 | 9.2 | 0.26 | 0.076 | 1.2 | — | Production was stopped, due to cracks occurred in the rolling. | | | | | |
| CE 11 | 9.2 | 0.24 | 0.071 | 0.008 | — | 80 | 1.0 × 10³ | 80 | 1.0 × 10³ | 350 | 1.0 × 10 |
| CE 12 | 9.2 | 0.23 | 0.072 | 0.07 | — | 130 | 1.0 × 10⁶ | 120 | 0.9 × 10⁶ | 600 | 1.0 × 10⁴ |
| | | | | | Compound Y2 | | | | | | Punch |
| | | | | | Size | Density | GS | TS | BP (R/t) | | -ability |
| | | | | | (nm) | (/mm²) | (μm) | (MPa) | GW | BW | (1) |
| | | | | Ex 1 | 700 | 0.9 × 10⁴ | 1.8 | 605 | ◯ | ◯ | [symbol] |
| | | | | Ex 2 | 700 | 0.9 × 10⁴ | 1.7 | 630 | ◯ | ◯ | [symbol] |
| | | | | Ex 3 | 700 | 0.9 × 10⁴ | 1.7 | 660 | ◯ | ◯ | [symbol] |
| | | | | Ex 4 | 650 | 0.9 × 10⁴ | 1.3 | 720 | ◯ | ◯ | [symbol] |
| | | | | Ex 5 | 650 | 0.9 × 10⁴ | 1.6 | 710 | ◯ | ◯ | [symbol] |
| | | | | Ex 6 | 800 | 0.9 × 10⁴ | 1.6 | 700 | ◯ | ◯ | [symbol] |
| | | | | Ex 7 | 500 | 0.9 × 10² | 4.9 | 670 | ◯ | ◯ | ◯ |
| | | | | Ex 8 | 2000 | 0.9 × 10⁶ | 1.1 | 730 | ◯ | ◯ | [symbol] |
| | | | | Ex 9 | 800 | 0.9 × 10³ | 3.2 | 700 | ◯ | ◯ | ◯ |
| | | | | Ex 10 | 700 | 0.9 × 10⁴ | 1.5 | 720 | ◯ | ◯ | [symbol] |
| | | | | Ex 11 | 750 | 0.9 × 10⁴ | 1.5 | 760 | ◯ | ◯ | [symbol] |
| | | | | Ex 12 | 700 | 0.9 × 10⁴ | 1.3 | 800 | ◯ | ◯ | [symbol] |
| | | | | Ex 13 | 700 | 0.9 × 10⁵ | 1.3 | 720 | ◯ | ◯ | [symbol] |
| | | | | Ex 14 | 650 | 0.9 × 10⁵ | 1.3 | 715 | ◯ | ◯ | [symbol] |
| | | | | Ex 15 | 700 | 0.9 × 10⁵ | 1.3 | 720 | ◯ | ◯ | [symbol] |
| | | | | Ex 16 | 700 | 0.9 × 10⁵ | 1.3 | 725 | ◯ | ◯ | [symbol] |
| | | | | Ex 17 | 700 | 0.9 × 10⁴ | 1.3 | 805 | ◯ | ◯ | [symbol] |
| | | | | Ex 18 | 2600 | 0.9 × 10⁴ | 1.3 | 805 | ◯ | ◯ | [symbol] |
| | | | | CE 1 | 700 | 0.9 × 10⁴ | 6.1 | 580 | ◯ | ◯ | [symbol] |
| | | | | CE 2 | — | — | 10.8 | 670 | X | X | X |
| | | | | CE 3 | 700 | 0.9 × 10⁷ | 1.1 | 700 | X | X | [symbol] |
| | | | | CE 4 | 1100 | 0.9 × 10⁷ | 1.2 | 690 | X | X | ◯ |
| | | | | CE 5 | 800 | 0.9 × 10⁷ | 1.8 | 690 | X | X | ◯ |
| | | | | CE 6 | 500 | 0.9 × 10⁷ | 8.3 | 675 | X | X | X |
| | | | | CE 7 | 550 | 0.9 × 10⁵ | 1.1 | 810 | X | X | [symbol] |
| | | | | CE 8 | 500 | 0.9 × 10 | 1.1 | 720 | ◯ | ◯ | X |
| | | | | CE 9 | 900 | 0.9 × 10⁶ | 8.9 | 670 | X | X | [symbol] |
| | | | | CE 10 | Production was stopped, due to cracks occurred in the rolling. | | | | | | |
| | | | | CE 11 | 550 | 1.0 × 10 | 6.2 | 760 | ◯ | X | X |
| | | | | CE 12 | 550 | 0.9 × 10⁴ | 0.8 | 820 | X | X | [symbol] |

(Note)
Compound X1: Compound with diameter 30 to 300 nrn;
Compound X2: Compound with diameter 50 to 200 nm
Compound Y1: Compound with diameter more than 0.3 μm and not more than 5.0 μm;
Compound Y2: Compound with diameter 0.5 μm to 3.0 μm
“—”: Not added for elements, and not formed for Compounds X, Y

As shown in Table 1, Examples 1 to 18 each exhibit excellent characteristics in the mechanical strength (tensile strength), the bending property, and the punching property.

Comparative example 1, which contained Sn less than 3.0 mass %, was large in grain size and low in mechanical strength (tensile strength). Comparative example 2 was so-called phosphor bronze obtained by adding only Sn and P to Cu, but since no compounds (X and Y) were present, the material was poor in mechanical strength (tensile strength), bending property, and punching property. Comparative example 3 had a total content of Fe and Ni which exceeded the upper limit, and was too large in the number of compounds Y, resulting in poor in bending property. Comparative examples 4 and 5 each had a sum total content of Fe and Ni which exceeded the upper limit, and was too large in the number of compounds Y, resulting in poor in bending property. Comparative example 6 had a total content of Fe and Ni which was lower than the lower limit, and the grain size was large, also the amounts of compounds X and Y each were too small, resulting in poor in bending property and punching property. Comparative example 7 had a content of Sn which was more than the upper limit, and was poor in bending property. Comparative example 8 in which the cooling speed for casting was too fast, had small amounts of the compounds (crystallization products), also the density of the compound Y was lower than the lower limit, resulting in poor in punching property. Comparative example 9 in which the cooling speed for casting was too slow, had a small amount of the compound X formed, also coarse compounds (crystallization products) having a size larger than 5 μm were produced, resulting in poor in bending property. Comparative example 10 in which the content of P was too large, occurred cracks in the cold rolling, and the production of the sample was stopped. Comparative example 11 in which the content of P was too small, were small in the amounts of compounds X and Y formed, which were coarse particles each having a large particle size, and the material was poor in bending property and also poor in punching property. Comparative example 12, in which the heat treatment d was conducted at a temperature of less than 300° C., was insufficient in recrystallization, and the grain size was too small, resulting in poor in bending property.

Next, as modifications of Example 4, the results (Examples 4-2 to 4-4) are shown in Table 2, which were to investigate the effects obtained when changing the ratio expressed by: {(density of compound Y in a region within 10% in sheet thickness from the sheet surface layer)/(density of compound Y in a region from 40% to 60% in sheet thickness from the sheet surface layer)}, as a presence density of the compound Y in the sheet thickness direction. The ratio described above was controlled by changing the amount face-milled. That is, sheet materials were obtained in the same manner as in Example 4, except that the amount face-milled of one face was changed to 2 mm in Example 4-2, to 1 mm in Example 4-3, and to 0.5 mm in Example 4-4, respectively, while in Example 4, the front and rear faces were face-milled in thickness of 3 mm each.

TABLE 2

| | | | | | | Compound X1 | | Compound X2 | | Compound Y1 | |
|---|---|---|---|---|---|---|---|---|---|---|---|
| | | Elements (mass %) | | | | Size | Density | Size | Density | Size | Density |
| | Ds/Dc | Sn | Fe | Ni | P | (nm) | (/mm²) | (nm) | (/mm²) | (cm) | (/mm²) |
| Ex 4-2 | 1.0 | 9.2 | 0.23 | 0.072 | 0.073 | 100 | 1.0 × 10⁶ | 95 | 0.9 × 10⁶ | 600 | 1.0 × 10⁴ |
| Ex 4-3 | 0.8 | 9.2 | 0.23 | 0.072 | 0.073 | 100 | 1.0 × 10⁶ | 95 | 0.9 × 10⁶ | 600 | 1.0 × 10⁴ |
| Ex 4-4 | 1.2 | 9.2 | 0.23 | 0.072 | 0.073 | 100 | 1.0 × 10⁶ | 95 | 0.9 × 10⁶ | 600 | 1.0 × 10⁴ |

| | Compound Y2 | | | | | | Punch |
|---|---|---|---|---|---|---|---|
| | Size | Density | GS | TS | BP (R/t) | | -ability |
| | (nm) | (/mm²) | (μm) | (MPa) | GW | BW | (1) |
| Ex 4-2 | 650 | 0.9 × 10⁴ | 1.3 | 720 | ◯ | ◯ | [symbol] |
| Ex 4-3 | 650 | 0.9 × 10⁴ | 1.3 | 720 | ◯ | ◯ | ◯ |
| Ex 4-4 | 650 | 0.9 × 10⁴ | 1.3 | 720 | ◯ | ◯ | Δ |

(Note)
Ds: the density of the compound Y in a region within 10% in sheet thickness from the sheet surface layer
Dc: the density of the compound Y in a region from 40% to 60% in sheet thickness from the sheet surface layer

As shown in Table 2, Example 4-2, which was the case where the amount face-milled of one surface was 2 mm, exhibited particularly excellent punching property. Example 4-3, which was the case where the amount face-milled of one surface was 1 mm, exhibited satisfactory punching property. With respect to Example 4-4, which was the case where the amount face-milled of one surface was 0.5 mm, since the density of the compound Y at the sheet surface layer side was high, the punching property was still satisfactory, although fluctuation was seen as compared with Example 4-2 and Example 4-3.

Next, as modifications of Example 4, the results (Examples 4-5 to 4-7) are shown in Table 3, which were to investigate the influence of the heat treatment (b, d) and the cold rolling (b, d). Sheet materials were obtained in the same manner as in Example 4, except that the heat treatment b and the cold rolling b were omitted in Example 4-5, that the heat treatment d and the cold rolling d were omitted in Example 4-6, and that the heat treatment b, the heat treatment d, the cold rolling b, and the cold rolling d were omitted in Example 4-7, respectively.

TABLE 3

| | | | | | Compound X1 | | Compound X2 | | Compound Y1 | | Compound Y2 | | | | | | Punch |
|---|---|---|---|---|---|---|---|---|---|---|---|---|---|---|---|---|---|
| | Elements (mass %) | | | | Size | Density | Size | Density | Size | Density | Size | Density | GS | TS | BP (R/t) | | -ability |
| | Sn | Fe | Ni | P | (nm) | (/mm²) | (nm) | (/mm²) | (nm) | (/mm²) | (nm) | (/mm²) | (μm) | (MPa) | GW | BW | (1) |
| Ex 4 | 9.2 | 0.23 | 0.072 | 0.07 | 100 | 1.0 × 10⁶ | 95 | 0.9 × 10⁶ | 600 | 1.0 × 10⁴ | 700 | 0.9 × 10⁴ | 1.3 | 720 | ◯ | ◯ | [symbol] |
| Ex 4-5 | 9.2 | 0.23 | 0.072 | 0.07 | 100 | 1.0 × 10⁶ | 95 | 0.9 × 10⁶ | 600 | 1.0 × 10⁴ | 700 | 0.9 × 10⁴ | 2.3 | 715 | ◯ | ◯ | [symbol] |
| Ex 4-6 | 9.2 | 0.23 | 0.072 | 0.07 | 100 | 1.0 × 10⁶ | 95 | 0.9 × 10⁶ | 600 | 1.0 × 10⁴ | 700 | 0.9 × 10⁴ | 4 | 690 | ◯ | ◯ | [symbol] |
| Ex 4-7 | 9.2 | 0.23 | 0.072 | 0.07 | 100 | 1.0 × 10⁵ | 95 | 0.9 × 10⁵ | 600 | 1.0 × 10³ | 700 | 0.9 × 10³ | 4.5 | 680 | ◯ | ◯ | ◯ |

As shown in Table 3, Examples 4-5 to 4-7 each exhibited satisfactory characteristics. In this regard, it is understood that it is particularly preferable, as in Example 4, to conduct all of the heat treatment b, the heat treatment d, the cold rolling b, and the cold rolling d, to repeat a combination of heat treatment and annealing for four times in total.

Next, Table 4 shows the results of performing the tests in the same manner as in Examples 1 to 4, except that the conditions of the homogenization heat treatment were changed. In Examples 1A to 1N, Examples 2A to 2N, Examples 3A to 3N, and Examples 4A to 4N, sheet materials were obtained by the same steps as those of Examples 1 to 4, except that the homogenization heat treatment conditions were changed, using the same ingots as those in Examples 1 to 4, respectively.

For the evaluation results of press punching property as shown in Table 4, the evaluation was carried out under the same conditions as in Tables 1 to 3, but the evaluation criteria on the number of shots were changed. That is, a sample which gave a minimum value of the number of shots of 5 million times or more, was judged to have a particularly excellent punchability, and is indicated in the table as “ [symbol] .” A sample which gave a minimum value of the number of shots of not less than 3 million times but less than 5 million times, was judged to have a satisfactory punchability, and is indicated in the table as “∘.” A sample which gave an average value of the number of shots of 3 million times or more, was judged to have a satisfactory punchability, but which gave a minimum value of the number of shots of less than 3 million times, caused fluctuations, is indicated in the table as “Δ.” A sample which gave an average value of the number of shots of less than 3 million times, was judged to have a poor punchability, and is indicated in the table as “×.” These evaluation results are shown as “Punchability (2)” in the following table.

TABLE 4

| | | | | | | Homogenization | | | | | | | |
|---|---|---|---|---|---|---|---|---|---|---|---|---|---|
| | | | | | | conditions | | Compound X1 | | Compound X2 | | Compound Y1 | |
| | Elements (mass %) | | | | | Temp | Time | Size | Density | Size | Density | Size | Density |
| | Sn | Fe | Ni | P | Other | (° C.) | (hr) | (nm) | (/mm²) | (nm) | (/mm²) | (nm) | (/mm²) |
| Ex 1 | 3 | 0.21 | 0.081 | 0.07 | | 800 | 1 | 105 | 1.0 × 10⁶ | 95 | 0.9 × 10⁶ | 600 | 1.0 × 10⁴ |
| Ex 1A | 3 | 0.21 | 0.081 | 0.07 | | 750 | 1 | 105 | 1.0 × 10⁶ | 95 | 0.9 × 10⁶ | 600 | 2.0 × 10⁴ |
| Ex 1B | 3 | 0.21 | 0.081 | 0.07 | | 750 | 2 | 105 | 1.0 × 10⁶ | 95 | 0.9 × 10⁶ | 600 | 1.8 × 10⁴ |
| Ex 1C | 3 | 0.21 | 0.081 | 0.07 | | 750 | 3 | 105 | 1.0 × 10⁶ | 95 | 0.9 × 10⁶ | 600 | 1.6 × 10⁴ |
| Ex 1D | 3 | 0.21 | 0.081 | 0.07 | | 750 | 5 | 105 | 1.0 × 10⁶ | 95 | 0.9 × 10⁶ | 600 | 1.6 × 10⁴ |
| Ex 1E | 3 | 0.21 | 0.081 | 0.07 | | 700 | 1.5 | 105 | 1.0 × 10⁶ | 95 | 0.9 × 10⁶ | 600 | 3.0 × 10⁴ |
| Ex 1F | 3 | 0.21 | 0.081 | 0.07 | | 700 | 3 | 105 | 1.0 × 10⁶ | 95 | 0.9 × 10⁶ | 600 | 3.0 × 10⁴ |
| Ex 1G | 3 | 0.21 | 0.081 | 0.07 | | 700 | 5 | 105 | 1.0 × 10⁶ | 95 | 0.9 × 10⁶ | 600 | 2.5 × 10⁴ |
| Ex 1H | 3 | 0.21 | 0.081 | 0.07 | | 650 | 2 | 105 | 1.0 × 10⁶ | 95 | 0.9 × 10⁶ | 600 | 5.0 × 10⁴ |
| Ex 1I | 3 | 0.21 | 0.081 | 0.07 | | 650 | 4 | 105 | 1.0 × 10⁶ | 95 | 0.9 × 10⁶ | 600 | 5.0 × 10⁴ |
| Ex 1J | 3 | 0.21 | 0.081 | 0.07 | | 650 | 6 | 105 | 1.0 × 10⁶ | 95 | 0.9 × 10⁶ | 600 | 4.0 × 10⁴ |
| Ex 1K | 3 | 0.21 | 0.081 | 0.07 | | 800 | 0.5 | 105 | 1.0 × 10⁶ | 95 | 0.9 × 10⁶ | 550 | 1.0 × 10⁴ |
| Ex 1L | 3 | 0.21 | 0.081 | 0.07 | | 800 | 2 | 105 | 1.0 × 10⁶ | 95 | 0.9 × 10⁶ | 550 | 0.9 × 10⁴ |
| Ex 1M | 3 | 0.21 | 0.081 | 0.07 | | 850 | 0.5 | 105 | 1.0 × 10⁶ | 95 | 0.9 × 10⁶ | 550 | 0.5 × 10⁴ |
| Ex 1N | 3 | 0.21 | 0.081 | 0.07 | | 850 | 1 | 105 | 1.0 × 10⁶ | 95 | 0.9 × 10⁶ | 550 | 0.4 × 10⁴ |
| Ex 2 | 5.2 | 0.23 | 0.079 | 0.07 | | 800 | 1 | 110 | 1.0 × 10⁶ | 105 | 0.9 × 10⁶ | 600 | 1.0 × 10⁴ |
| Ex 2A | 5.2 | 0.23 | 0.079 | 0.07 | | 750 | 1 | 110 | 1.0 × 10⁶ | 105 | 0.9 × 10⁶ | 600 | 2.0 × 10⁴ |
| Ex 2B | 5.2 | 0.23 | 0.079 | 0.07 | | 750 | 2 | 110 | 1.0 × 10⁶ | 105 | 0.9 × 10⁶ | 600 | 1.8 × 10⁴ |
| Ex 2C | 5.2 | 0.23 | 0.079 | 0.07 | | 750 | 3 | 110 | 1.0 × 10⁶ | 105 | 0.9 × 10⁶ | 600 | 1.6 × 10⁴ |
| Ex 2D | 5.2 | 0.23 | 0.079 | 0.07 | | 750 | 5 | 110 | 1.0 × 10⁶ | 105 | 0.9 × 10⁶ | 600 | 1.6 × 10⁴ |
| Ex 2E | 5.2 | 0.23 | 0.079 | 0.07 | | 700 | 1.5 | 110 | 1.0 × 10⁶ | 105 | 0.9 × 10⁶ | 600 | 3.0 × 10⁴ |
| Ex 2F | 5.2 | 0.23 | 0.079 | 0.07 | | 700 | 3 | 110 | 1.0 × 10⁶ | 105 | 0.9 × 10⁶ | 600 | 3.0 × 10⁴ |
| Ex 2G | 5.2 | 0.23 | 0.079 | 0.07 | | 700 | 5 | 110 | 1.0 × 10⁶ | 105 | 0.9 × 10⁶ | 600 | 2.5 × 10⁴ |
| Ex 2H | 5.2 | 0.23 | 0.079 | 0.07 | | 650 | 2 | 110 | 1.0 × 10⁶ | 105 | 0.9 × 10⁶ | 600 | 5.0 × 10⁴ |
| Ex 2I | 5.2 | 0.23 | 0.079 | 0.07 | | 650 | 4 | 110 | 1.0 × 10⁶ | 105 | 0.9 × 10⁶ | 600 | 5.0 × 10⁴ |
| Ex 2J | 5.2 | 0.23 | 0.079 | 0.07 | | 650 | 6 | 110 | 1.0 × 10⁶ | 105 | 0.9 × 10⁶ | 600 | 4.0 × 10⁴ |
| Ex 2K | 5.2 | 0.23 | 0.079 | 0.07 | | 800 | 0.5 | 110 | 1.0 × 10⁶ | 105 | 0.9 × 10⁶ | 550 | 1.0 × 10⁴ |
| Ex 2L | 5.2 | 0.23 | 0.079 | 0.07 | | 800 | 2 | 110 | 1.0 × 10⁶ | 105 | 0.9 × 10⁶ | 550 | 0.9 × 10⁴ |
| Ex 2M | 5.2 | 0.23 | 0.079 | 0.07 | | 850 | 0.5 | 110 | 1.0 × 10⁶ | 105 | 0.9 × 10⁶ | 550 | 0.5 × 10⁴ |
| Ex 2N | 5.2 | 0.23 | 0.079 | 0.07 | | 850 | 1 | 110 | 1.0 × 10⁶ | 105 | 0.9 × 10⁶ | 550 | 0.4 × 10⁴ |
| Ex 3 | 7.3 | 0.25 | 0.076 | 0.07 | | 800 | 1 | 110 | 1.0 × 10⁶ | 105 | 0.9 × 10⁶ | 600 | 1.0 × 10⁴ |
| Ex 3A | 7.3 | 0.25 | 0.076 | 0.07 | | 750 | 1 | 110 | 1.0 × 10⁶ | 105 | 0.9 × 10⁶ | 600 | 2.0 × 10⁴ |
| Ex 3B | 7.3 | 0.25 | 0.076 | 0.07 | | 750 | 2 | 110 | 1.0 × 10⁶ | 105 | 0.9 × 10⁶ | 600 | 1.8 × 10⁴ |
| Ex 3C | 7.3 | 0.25 | 0.076 | 0.07 | | 750 | 3 | 110 | 1.0 × 10⁶ | 105 | 0.9 × 10⁶ | 600 | 1.6 × 10⁴ |
| Ex 3D | 7.3 | 0.25 | 0.076 | 0.07 | | 750 | 5 | 110 | 1.0 × 10⁶ | 105 | 0.9 × 10⁶ | 600 | 1.6 × 10⁴ |
| Ex 3E | 7.3 | 0.25 | 0.076 | 0.07 | | 700 | 1.5 | 110 | 1.0 × 10⁶ | 105 | 0.9 × 10⁶ | 600 | 3.0 × 10⁴ |
| Ex 3F | 7.3 | 0.25 | 0.076 | 0.07 | | 700 | 3 | 110 | 1.0 × 10⁶ | 105 | 0.9 × 10⁶ | 600 | 3.0 × 10⁴ |
| Ex 3G | 7.3 | 0.25 | 0.076 | 0.07 | | 700 | 5 | 110 | 1.0 × 10⁶ | 105 | 0.9 × 10⁶ | 600 | 2.5 × 10⁴ |
| Ex 3H | 7.3 | 0.25 | 0.076 | 0.07 | | 650 | 2 | 110 | 1.0 × 10⁶ | 105 | 0.9 × 10⁶ | 600 | 5.0 × 10⁴ |
| Ex 3I | 7.3 | 0.25 | 0.076 | 0.07 | | 650 | 4 | 110 | 1.0 × 10⁶ | 105 | 0.9 × 10⁶ | 600 | 5.0 × 10⁴ |
| Ex 3J | 7.3 | 0.25 | 0.076 | 0.07 | | 650 | 6 | 110 | 1.0 × 10⁶ | 105 | 0.9 × 10⁶ | 600 | 4.0 × 10⁴ |
| Ex 3K | 7.3 | 0.25 | 0.076 | 0.07 | | 800 | 0.5 | 110 | 1.0 × 10⁶ | 105 | 0.9 × 10⁶ | 600 | 1.0 × 10⁴ |
| Ex 3L | 7.3 | 0.25 | 0.076 | 0.07 | | 800 | 2 | 110 | 1.0 × 10⁶ | 105 | 0.9 × 10⁶ | 550 | 0.9 × 10⁴ |
| Ex 3M | 7.3 | 0.25 | 0.076 | 0.07 | | 850 | 0.5 | 110 | 1.0 × 10⁶ | 105 | 0.9 × 10⁶ | 550 | 0.5 × 10⁴ |
| Ex 3N | 7.3 | 0.25 | 0.076 | 0.07 | | 850 | 1 | 110 | 1.0 × 10⁶ | 105 | 0.9 × 10⁶ | 550 | 0.4 × 10⁴ |
| Ex 4 | 9.2 | 0.23 | 0.072 | 0.07 | | 800 | 1 | 100 | 1.0 × 10⁶ | 95 | 0.9 × 10⁶ | 600 | 1.0 × 10⁴ |
| Ex 4A | 9.2 | 0.23 | 0.072 | 0.07 | | 750 | 1 | 100 | 1.0 × 10⁶ | 95 | 0.9 × 10⁶ | 600 | 2.0 × 10⁴ |
| Ex 4B | 9.2 | 0.23 | 0.072 | 0.07 | | 750 | 2 | 100 | 1.0 × 10⁶ | 95 | 0.9 × 10⁶ | 600 | 1.8 × 10⁴ |
| Ex 4C | 9.2 | 0.23 | 0.072 | 0.07 | | 750 | 3 | 100 | 1.0 × 10⁶ | 95 | 0.9 × 10⁶ | 600 | 1.6 × 10⁴ |
| Ex 4D | 9.2 | 0.23 | 0.072 | 0.07 | | 750 | 5 | 100 | 1.0 × 10⁶ | 95 | 0.9 × 10⁶ | 600 | 1.6 × 10⁴ |
| Ex 4E | 9.2 | 0.23 | 0.072 | 0.07 | | 700 | 1.5 | 100 | 1.0 × 10⁶ | 95 | 0.9 × 10⁶ | 600 | 3.0 × 10⁴ |
| Ex 4F | 9.2 | 0.23 | 0.072 | 0.07 | | 700 | 3 | 100 | 1.0 × 10⁶ | 95 | 0.9 × 10⁶ | 600 | 3.0 × 10⁴ |
| Ex 4G | 9.2 | 0.23 | 0.072 | 0.07 | | 700 | 5 | 100 | 1.0 × 10⁶ | 95 | 0.9 × 10⁶ | 600 | 2.5 × 10⁴ |
| Ex 4H | 9.2 | 0.23 | 0.072 | 0.07 | | 650 | 2 | 100 | 1.0 × 10⁶ | 95 | 0.9 × 10⁶ | 600 | 5.0 × 10⁴ |
| Ex 4I | 9.2 | 0.23 | 0.072 | 0.07 | | 650 | 4 | 100 | 1.0 × 10⁶ | 95 | 0.9 × 10⁶ | 600 | 5.0 × 10⁴ |
| Ex 4J | 9.2 | 0.23 | 0.072 | 0.07 | | 650 | 6 | 100 | 1.0 × 10⁶ | 95 | 0.9 × 10⁶ | 600 | 4.0 × 10⁴ |
| Ex 4K | 9.2 | 0.23 | 0.072 | 0.07 | | 800 | 0.5 | 100 | 1.0 × 10⁶ | 95 | 0.9 × 10⁶ | 600 | 1.0 × 10⁴ |
| Ex 4L | 9.2 | 0.23 | 0.072 | 0.07 | | 800 | 2 | 100 | 1.0 × 10⁶ | 95 | 0.9 × 10⁶ | 550 | 0.9 × 10⁴ |
| Ex 4M | 9.2 | 0.23 | 0.072 | 0.07 | | 850 | 0.5 | 100 | 1.0 × 10⁶ | 95 | 0.9 × 10⁶ | 550 | 0.5 × 10⁴ |
| Ex 4N | 9.2 | 0.23 | 0:072 | 0.07 | | 850 | 1 | 100 | 1.0 × 10⁶ | 95 | 0.9 × 10⁶ | 550 | 0.4 × 10⁴ |

| | Compound Y2 | | | | | | Punch |
|---|---|---|---|---|---|---|---|
| | Size | Density | GS | TS | BP (R/t) | | -ability |
| | (nm) | (/mm²) | (μm) | (MPa) | GW | BW | (2) |
| Ex 1 | 700 | 0.9 × 10⁴ | 1.8 | 605 | ◯ | ◯ | ◯ |
| Ex 1A | 700 | 1.5 × 10⁴ | 1.8 | 600 | ◯ | ◯ | [symbol] |
| Ex 1B | 700 | 1.4 × 10⁴ | 1.8 | 600 | ◯ | ◯ | [symbol] |
| Ex 1C | 700 | 1.3 × 10⁴ | 1.8 | 605 | ◯ | ◯ | [symbol] |
| Ex 1D | 700 | 1.3 × 10⁴ | 1.8 | 600 | ◯ | ◯ | [symbol] |
| Ex 1E | 700 | 2.0 × 10⁴ | 1.8 | 600 | ◯ | ◯ | [symbol] |
| Ex 1F | 700 | 2.0 × 10⁴ | 1.8 | 600 | ◯ | ◯ | [symbol] |
| Ex 1G | 700 | 2.3 × 10⁴ | 1.8 | 600 | ◯ | ◯ | [symbol] |
| Ex 1H | 700 | 4.0 × 10⁴ | 1.9 | 595 | ◯ | ◯ | [symbol] |
| Ex 1I | 700 | 4.0 × 10⁴ | 1.9 | 595 | ◯ | ◯ | [symbol] |
| Ex 1J | 700 | 3.5 × 10⁴ | 1.9 | 595 | ◯ | ◯ | [symbol] |
| Ex 1K | 650 | 0.9 × 10⁴ | 1.8 | 600 | ◯ | ◯ | ◯ |
| Ex 1L | 650 | 0.8 × 10⁴ | 1.8 | 600 | ◯ | ◯ | Δ |
| Ex 1M | 650 | 0.4 × 10⁴ | 1.8 | 600 | ◯ | ◯ | Δ |
| Ex 1N | 650 | 0.4 × 10⁴ | 1.8 | 600 | ◯ | ◯ | Δ |
| Ex 2 | 700 | 0.9 × 10⁴ | 1.7 | 630 | ◯ | ◯ | ◯ |
| Ex 2A | 700 | 1.5 × 10⁴ | 1.7 | 625 | ◯ | ◯ | [symbol] |
| Ex 2B | 700 | 1.4 × 10⁴ | 1.7 | 625 | ◯ | ◯ | [symbol] |
| Ex 2C | 700 | 1.3 × 10⁴ | 1.7 | 630 | ◯ | ◯ | [symbol] |
| Ex 2D | 700 | 1.3 × 10⁴ | 1.7 | 625 | ◯ | ◯ | [symbol] |
| Ex 2E | 700 | 2.0 × 10⁴ | 1.7 | 625 | ◯ | ◯ | [symbol] |
| Ex 2F | 700 | 2.0 × 10⁴ | 1.7 | 625 | ◯ | ◯ | [symbol] |
| Ex 2G | 700 | 2.3 × 10⁴ | 1.7 | 625 | ◯ | ◯ | [symbol] |
| Ex 2H | 700 | 4.0 × 10⁴ | 1.8 | 625 | ◯ | ◯ | [symbol] |
| Ex 2I | 700 | 4.0 × 10⁴ | 1.8 | 625 | ◯ | ◯ | [symbol] |
| Ex 2J | 700 | 3.5 × 10⁴ | 1.7 | 625 | ◯ | ◯ | [symbol] |
| Ex 2K | 650 | 0.9 × 10⁴ | 1.7 | 625 | ◯ | ◯ | ◯ |
| Ex 2L | 650 | 0.8 × 10⁴ | 1.7 | 630 | ◯ | ◯ | Δ |
| Ex 2M | 650 | 0.4 × 10⁴ | 1.7 | 630 | ◯ | ◯ | Δ |
| Ex 2N | 650 | 0.4 × 10⁴ | 1.8 | 630 | ◯ | ◯ | Δ |
| Ex 3 | 700 | 0.9 × 10⁴ | 1.7 | 660 | ◯ | ◯ | ◯ |
| Ex 3A | 700 | 1.5 × 10⁴ | 1.7 | 655 | ◯ | ◯ | [symbol] |
| Ex 3B | 700 | 1.4 × 10⁴ | 1.7 | 655 | ◯ | ◯ | [symbol] |
| Ex 3C | 700 | 1.3 × 10⁴ | 1.7 | 650 | ◯ | ◯ | [symbol] |
| Ex 3D | 700 | 1.3 × 10⁴ | 1.7 | 650 | ◯ | ◯ | [symbol] |
| Ex 3E | 700 | 2.0 × 10⁴ | 1.7 | 650 | ◯ | ◯ | [symbol] |
| Ex 3F | 700 | 2.0 × 10⁴ | 1.7 | 650 | ◯ | ◯ | [symbol] |
| Ex 3G | 700 | 2.3 × 10⁴ | 1.7 | 655 | ◯ | ◯ | [symbol] |
| Ex 3H | 700 | 4.0 × 10⁴ | 1.7 | 650 | ◯ | ◯ | [symbol] |
| Ex 3I | 700 | 4.0 × 10⁴ | 1.7 | 650 | ◯ | ◯ | [symbol] |
| Ex 3J | 700 | 3.5 × 10⁴ | 1.7 | 650 | ◯ | ◯ | [symbol] |
| Ex 3K | 650 | 0.9 × 10⁴ | 1.7 | 665 | ◯ | ◯ | ◯ |
| Ex 3L | 650 | 0.8 × 10⁴ | 1.7 | 665 | ◯ | ◯ | Δ |
| Ex 3M | 650 | 0.4 × 10⁴ | 1.7 | 665 | ◯ | ◯ | Δ |
| Ex 3N | 650 | 0.4 × 10⁴ | 1.7 | 670 | ◯ | ◯ | Δ |
| Ex 4 | 650 | 0.9 × 10⁴ | 1.3 | 720 | ◯ | ◯ | ◯ |
| Ex 4A | 700 | 1.5 × 10⁴ | 1.3 | 715 | ◯ | ◯ | [symbol] |
| Ex 4B | 700 | 1.4 × 10⁴ | 1.3 | 715 | ◯ | ◯ | [symbol] |
| Ex 4C | 700 | 1.3 × 10⁴ | 1.3 | 710 | ◯ | ◯ | [symbol] |
| Ex 4D | 700 | 1.3 × 10⁴ | 1.3 | 710 | ◯ | ◯ | [symbol] |
| Ex 4E | 700 | 2.0 × 10⁴ | 1.3 | 715 | ◯ | ◯ | [symbol] |
| Ex 4F | 700 | 2.0 × 10⁴ | 1.3 | 715 | ◯ | ◯ | [symbol] |
| Ex 4G | 700 | 2.3 × 10⁴ | 1.3 | 710 | ◯ | ◯ | [symbol] |
| Ex 4H | 700 | 4.0 × 10⁴ | 1.3 | 710 | ◯ | ◯ | [symbol] |
| Ex 4I | 700 | 4.0 × 10⁴ | 1.3 | 710 | ◯ | ◯ | [symbol] |
| Ex 4J | 700 | 3.5 × 10⁴ | 1.3 | 710 | ◯ | ◯ | [symbol] |
| Ex 4K | 650 | 0.9 × 10⁴ | 1.3 | 725 | ◯ | ◯ | ◯ |
| Ex 4L | 650 | 0.8 × 10⁴ | 1.3 | 725 | ◯ | ◯ | Δ |
| Ex 4M | 650 | 0.4 × 10⁴ | 1.3 | 725 | ◯ | ◯ | Δ |
| Ex 4N | 650 | 0.4 × 10⁴ | 1.3 | 725 | ◯ | ◯ | Δ |

As shown in Table 4, the density of the compound Y increased in each of the cases of Examples 1A to 1J as compared with Example 1, Examples 2A to 2J as compared with Example 2, Examples 3A to 3J as compared with Example 3, and Example 4A to 4J as compared with Example 4, respectively. Thus, the fluctuation in the number of shots in press-punching was small, and the punching property was particularly excellent. In addition, the density of the compound Y decreased in each of the cases of Examples 1L to 1N as compared with Example 1, Examples 2L to 2N as compared with Example 2, Examples 3L to 3N as compared with Example 3, and Example 4L to 4N as compared with Example 4, respectively. Thus, Examples 1 to 4 exhibited results with superior punching property to those, respectively.

Next, Examples 19 to 56 in which the homogenization heat treatment conditions and were changed variously in the preferred ranges according to the present invention, are shown in Table 5. The evaluation results for the press punching property shown in Table 5 were obtained by the same evaluation conditions as those in Table 4.

TABLE 5

| | | | | | | Homogenization | | | | | | | |
|---|---|---|---|---|---|---|---|---|---|---|---|---|---|
| | Elements (mass %) | | | | | conditions | | Compound X1 | | Compound X2 | | Compound Y1 | |
| | | | | | Other | Temp | Time | Size | Density | Size | Density | Size | Density |
| | Sn | Fe | Ni | P | element | (° C.) | (hr) | (nm) | (/mm²) | (nm) | (/mm²) | (nm) | (/mm²) |
| Ex 19 | 7.3 | 0.08 | 0.076 | 0.07 | | 700 | 2 | 100 | 1.0 × 10⁶ | 90 | 0.9 × 10⁶ | 600 | 1.5 × 10⁴ |
| Ex 20 | 7.3 | 1.02 | 0.042 | 0.07 | | 650 | 5 | 110 | 1.0 × 10⁶ | 105 | 0.9 × 10⁶ | 600 | 3.0 × 10⁵ |
| Ex 21 | 7.3 | 0.02 | 0.018 | 0.07 | | 700 | 5 | 80 | 1.0 × 10⁶ | 75 | 0.9 × 10⁶ | 400 | 2.0 × 10⁴ |
| Ex 22 | 7.3 | 0.22 | 0.076 | 0.07 | | 650 | 8 | 130 | 1.0 × 10⁶ | 120 | 0.9 × 10⁶ | 550 | 4.0 × 10⁴ |
| Ex 23 | 7.3 | 0.18 | 0.076 | 0.07 | | 650 | 2 | 110 | 1.0 × 10⁶ | 105 | 0.9 × 10⁶ | 600 | 2.5 × 10⁴ |
| Ex 24 | 7.3 | 0.1 | 0.05 | 0.07 | | 700 | 3 | 110 | 1.0 × 10⁶ | 105 | 0.9 × 10⁶ | 600 | 2.0 × 10⁴ |
| Ex 25 | 8.1 | 0.11 | 0.072 | 0.07 | | 700 | 3 | 110 | 1.0 × 10⁶ | 105 | 0.9 × 10⁶ | 600 | 3.0 × 10⁴ |
| Ex 26 | 9.2 | 0.13 | 0.075 | 0.07 | | 700 | 3 | 110 | 1.0 × 10⁶ | 105 | 0.9 × 10⁶ | 600 | 3.0 × 10⁴ |
| Ex 27 | 9.8 | 0.11 | 0.058 | 0.05 | | 700 | 3 | 110 | 1.0 × 10⁶ | 105 | 0.9 × 10⁶ | 600 | 3.0 × 10⁴ |
| Ex 28 | 10.2 | 0.14 | 0.053 | 0.06 | | 700 | 3 | 110 | 1.0 × 10⁶ | 105 | 0.9 × 10⁶ | 600 | 3.0 × 10⁴ |
| Ex 29 | 12.2 | 0.08 | 0.042 | 0.05 | | 700 | 3 | 110 | 1.0 × 10⁶ | 105 | 0.9 × 10⁶ | 600 | 3.0 × 10⁴ |
| Ex 30 | 12.9 | 0.1 | 0.042 | 0.05 | | 700 | 3 | 110 | 1.0 × 10⁶ | 105 | 0.9 × 10⁶ | 600 | 3.0 × 10⁴ |
| Ex 31 | 8.1 | 0.12 | 0.07 | 0.09 | Co: 0.1 | 650 | 2 | 115 | 1.5 × 10⁶ | 110 | 1.2 × 10⁶ | 650 | 5.0 × 10⁴ |
| Ex 32 | 8.1 | 0.12 | 0.08 | 0.08 | Cr: 0.1 | 650 | 2 | 115 | 1.5 × 10⁶ | 110 | 1.2 × 10⁶ | 650 | 5.0 × 10⁴ |
| Ex 33 | 8.1 | 0.3 | 0.13 | 0.13 | Mn: 0.1 | 650 | 2 | 115 | 1.5 × 10⁶ | 110 | 1.2 × 10⁶ | 650 | 5.0 × 10⁴ |
| Ex 34 | 10.1 | 0.11 | 0.15 | 0.11 | Co: 0.1 | 650 | 2 | 115 | 1.5 × 10⁶ | 110 | 1.2 × 10⁶ | 650 | 5.0 × 10⁴ |
| Ex 35 | 10.1 | 0.2 | 0.09 | 0.08 | Cr: 0.1 | 650 | 2 | 115 | 1.5 × 10⁶ | 110 | 1.2 × 10⁶ | 650 | 5.0 × 10⁴ |
| Ex 36 | 10.1 | 0.23 | 0.1 | 0.07 | Mn: 0.1 | 650 | 2 | 115 | 1.5 × 10⁶ | 110 | 1.2 × 10⁶ | 650 | 5.0 × 10⁴ |
| Ex 37 | 10.1 | 0.2 | 0.2 | 0.1 | Co: 0.1, | 650 | 2 | 120 | 2.0 × 10⁶ | 110 | 1.5 × 10⁶ | 650 | 5.0 × 10⁴ |
| | | | | | Cr: 0.1 | | | | | | | | |
| Ex 38 | 10.1 | 0.4 | 0.3 | 0.15 | Co: 0.1, | 650 | 2 | 120 | 2.0 × 10⁶ | 110 | 1.5 × 10⁶ | 650 | 5.0 × 10⁴ |
| | | | | | Mn: 0.1 | | | | | | | | |
| Ex 39 | 9.1 | 0.19 | 0.086 | 0.08 | Co: 0.1 | 800 | 1 | 115 | 1.5 × 10⁶ | 110 | 1.2 × 10⁶ | 650 | 1.0 × 10⁴ |
| Ex 40 | 9.1 | 0.19 | 0.086 | 0.08 | Co: 0.1 | 750 | 1 | 115 | 1.5 × 10⁶ | 110 | 1.2 × 10⁶ | 650 | 2.0 × 10⁴ |
| Ex 41 | 9.1 | 0.19 | 0.086 | 0.08 | Co: 0.1 | 700 | 1.5 | 115 | 1.5 × 10⁶ | 110 | 1.2 × 10⁶ | 650 | 3.0 × 10⁴ |
| Ex 42 | 9.4 | 0.18 | 0.093 | 0.07 | Cr: 0.2 | 800 | 1 | 115 | 2.0 × 10⁶ | 110 | 1.5 × 10⁶ | 700 | 1.5 × 10⁴ |
| Ex 43 | 9.2 | 0.23 | 0.093 | 0.07 | Cr: 0.2 | 750 | 1 | 115 | 2.0 × 10⁶ | 110 | 1.5 × 10⁶ | 700 | 2.5 × 10⁴ |
| Ex 44 | 9.2 | 0.23 | 0.093 | 0.07 | Cr: 0.2 | 700 | 1.5 | 115 | 2.0 × 10⁶ | 110 | 1.5 × 10⁶ | 700 | 3.0 × 10⁴ |
| Ex 45 | 9.2 | 0.21 | 0.081 | 0.07 | Mn: 0.1 | 800 | 1 | 115 | 1.5 × 10⁶ | 110 | 1.2 × 10⁶ | 650 | 1.0 × 10⁴ |
| Ex 46 | 9.2 | 0.21 | 0.081 | 0.07 | Mn: 0.1 | 750 | 1 | 115 | 1.5 × 10⁶ | 110 | 1.2 × 10⁶ | 650 | 2.0 × 10⁴ |
| Ex 47 | 9.2 | 0.21 | 0.081 | 0.07 | Mn: 0.1 | 700 | 1.5 | 115 | 1.5 × 10⁶ | 110 | 1.2 × 10⁶ | 650 | 3.0 × 10⁴ |
| Ex 48 | 9.2 | 0.19 | 0.098 | 0.09 | Co: 0.1, | 800 | 1 | 120 | 2.0 × 10⁶ | 110 | 1.5 × 10⁶ | 700 | 1.5 × 10⁴ |
| | | | | | Cr: 0.1 | | | | | | | | |
| Ex 49 | 9.2 | 0.19 | 0.098 | 0.09 | Co: 0.1, | 750 | 1 | 120 | 2.0 × 10⁶ | 110 | 1.5 × 10⁶ | 700 | 2.5 × 10⁴ |
| | | | | | Cr: 0.1 | | | | | | | | |
| Ex 50 | 9.2 | 0.19 | 0.098 | 0.09 | Co: 0.1, | 700 | 1.5 | 120 | 2.0 × 10⁶ | 110 | 1.5 × 10⁶ | 700 | 3.0 × 10⁴ |
| | | | | | Cr: 0.1 | | | | | | | | |
| Ex 51 | 9.2 | 0.19 | 0.05 | 0.07 | Co: 0.1, | 800 | 1 | 120 | 2.0 × 10⁶ | 110 | 1.5 × 10⁶ | 700 | 1.5 × 10⁴ |
| | | | | | Mn: 0.1 | | | | | | | | |
| Ex 52 | 9.2 | 0.19 | 0.05 | 0.07 | Cr: 0.1, | 750 | 1 | 120 | 2.0 × 10⁶ | 110 | 1.5 × 10⁶ | 700 | 2.5 × 10⁴ |
| | | | | | Mn: 0.1 | | | | | | | | |
| Ex 53 | 9.2 | 0.19 | 0.05 | 0.07 | Cr: 0.1, | 700 | 1.5 | 120 | 2.0 × 10⁶ | 110 | 1.5 × 10⁶ | 700 | 3.0 × 10⁴ |
| | | | | | Mn: 0.1 | | | | | | | | |
| Ex 54 | 9.2 | 0.19 | 0.74 | 0.07 | Cr: 0.1, | 800 | 1 | 120 | 2.0 × 10⁶ | 110 | 1.5 × 10⁶ | 700 | 1.5 × 10⁴ |
| | | | | | Mn: 0.1 | | | | | | | | |
| Ex 55 | 9.2 | 0.19 | 0.74 | 0.07 | Cr: 0.1, | 750 | 1 | 120 | 2.0 × 10⁶ | 110 | 1.5 × 10⁶ | 700 | 2.5 × 10⁴ |
| | | | | | Mn: 0.1 | | | | | | | | |
| Ex 56 | 9.2 | 0.19 | 0.74 | 0.07 | Cr: 0.1, | 700 | 1.5 | 120 | 2.0 × 10⁶ | 110 | 1.5 × 10⁶ | 700 | 3.0 × 10⁴ |
| | | | | | Mn: 0.1 | | | | | | | | |

| | Compound Y2 | | | | | | Punch |
|---|---|---|---|---|---|---|---|
| | Size | Density | GS | TS | BP (R/t) | | -ability |
| | (nm) | (/mm²) | (μm) | (MPa) | GW | BW | (2) |
| Ex 19 | 650 | 1.2 × 10⁴ | 1.7 | 640 | ◯ | ◯ | [symbol] |
| Ex 20 | 700 | 2.0 × 10⁵ | 1.4 | 635 | ◯ | ◯ | [symbol] |
| Ex 21 | 500 | 1.0 × 10⁴ | 1.7 | 650 | ◯ | ◯ | [symbol] |
| Ex 22 | 700 | 3.0 × 10⁴ | 1.7 | 645 | ◯ | ◯ | [symbol] |
| Ex 23 | 650 | 2.0 × 10⁴ | 1.7 | 650 | ◯ | ◯ | [symbol] |
| Ex 24 | 700 | 1.5 × 10⁴ | 1.8 | 645 | ◯ | ◯ | [symbol] |
| Ex 25 | 700 | 2.0 × 10⁴ | 1.5 | 735 | ◯ | ◯ | [symbol] |
| Ex 26 | 700 | 2.0 × 10⁴ | 1.5 | 750 | ◯ | ◯ | [symbol] |
| Ex 27 | 700 | 2.0 × 10⁴ | 1.5 | 780 | ◯ | ◯ | [symbol] |
| Ex 28 | 700 | 2.0 × 10⁴ | 1.3 | 785 | ◯ | ◯ | [symbol] |
| Ex 29 | 700 | 2.0 × 10⁴ | 1.3 | 840 | ◯ | ◯ | [symbol] |
| Ex 30 | 700 | 2.0 × 10⁴ | 1.3 | 850 | ◯ | ◯ | [symbol] |
| Ex 31 | 750 | 4.0 × 10⁴ | 1.5 | 745 | ◯ | ◯ | [symbol] |
| Ex 32 | 750 | 4.0 × 10⁴ | 1.5 | 745 | ◯ | ◯ | [symbol] |
| Ex 33 | 750 | 4.0 × 10⁴ | 1.5 | 745 | ◯ | ◯ | [symbol] |
| Ex 34 | 750 | 4.0 × 10⁴ | 1.3 | 790 | ◯ | ◯ | [symbol] |
| Ex 35 | 750 | 4.0 × 10⁴ | 1.3 | 790 | ◯ | ◯ | [symbol] |
| Ex 36 | 750 | 4.0 × 10⁴ | 1.3 | 790 | ◯ | ◯ | [symbol] |
| Ex 37 | 750 | 4.0 × 10⁴ | 1.3 | 795 | ◯ | ◯ | [symbol] |
| Ex 38 | 750 | 4.0 × 10⁴ | 1.3 | 795 | ◯ | ◯ | [symbol] |
| Ex 39 | 750 | 0.9 × 10⁴ | 1.3 | 730 | ◯ | ◯ | ◯ |
| Ex 40 | 750 | 1.5 × 10⁴ | 1.3 | 730 | ◯ | ◯ | [symbol] |
| Ex 41 | 750 | 2.5 × 10⁴ | 1.3 | 730 | ◯ | ◯ | [symbol] |
| Ex 42 | 800 | 1.2 × 10⁴ | 13 | 735 | ◯ | ◯ | ◯ |
| Ex 43 | 800 | 2.0 × 10⁴ | 1.3 | 735 | ◯ | ◯ | [symbol] |
| Ex 44 | 800 | 2.5 × 10⁴ | 1.3 | 735 | ◯ | ◯ | [symbol] |
| Ex 45 | 750 | 0.9 × 10⁴ | 1.3 | 730 | ◯ | ◯ | ◯ |
| Ex 46 | 750 | 1.5 × 10⁴ | 1.3 | 730 | ◯ | ◯ | [symbol] |
| Ex 47 | 750 | 2.5 × 10⁴ | 1.3 | 730 | ◯ | ◯ | [symbol] |
| Ex 48 | 800 | 1.2 × 10⁴ | 1.3 | 735 | ◯ | ◯ | ◯ |
| Ex 49 | 800 | 2.0 × 10⁴ | 13 | 735 | ◯ | ◯ | [symbol] |
| Ex 50 | 800 | 2.5 × 10⁴ | 1.3 | 735 | ◯ | ◯ | [symbol] |
| Ex 51 | 800 | 1.2 × 10⁴ | 1.3 | 735 | ◯ | ◯ | ◯ |
| Ex 52 | 800 | 2.0 × 10⁴ | 1.3 | 735 | ◯ | ◯ | [symbol] |
| Ex 53 | 800 | 2.5 × 10⁴ | 1.3 | 735 | ◯ | ◯ | [symbol] |
| Ex 54 | 800 | 1.2 × 10⁴ | 1.3 | 735 | ◯ | ◯ | ◯ |
| Ex 55 | 800 | 2.0 × 10⁴ | 1.3 | 735 | ◯ | ◯ | [symbol] |
| Ex 56 | 800 | 2.5 × 10⁴ | 1.3 | 735 | ◯ | ◯ | [symbol] |

As shown in Table 5, in Examples 19 to 56, the fluctuation in the number of shots in press-punching was small, and the punching property was particularly excellent.

Next, Comparative examples 13 to 19, which are other comparative examples to Example 1, and the results thereof, are shown in Table 6.

TABLE 6

| | | | | | Compound X1 | | Compound X2 | | Compound Y1 | | Compound Y2 | | | | | | Punch |
|---|---|---|---|---|---|---|---|---|---|---|---|---|---|---|---|---|---|
| | Elements (mass %) | | | | Size | Density | Size | Density | Size | Density | Size | Density | GS | TS | BP (R/t) | | -ability |
| | Sn | Fe | Ni | P | (nm) | (/mm²) | (nm) | (/mm²) | (nm) | (/mm²) | (mn) | (/mm²) | (μm) | (MPa) | GW | BW | (1) |
| CE 13 | 6.1 | 0.5 | 0.5 | 0.13 | 100 | 1.0 × 10⁴ | 95 | 0.9 × 10⁴ | 450 | 1.0 × 10² | 500 | 0.9 × 10² | 4.3 | 640 | ◯ | ◯ | X |
| CE 14 | 6.1 | 0.5 | 0.5 | 0.13 | 100 | 1.0 × 10⁴ | 95 | 0.9 × 10⁴ | 450 | 1.0 × 10² | 500 | 0.9 × 10² | 2.5 | 690 | ◯ | ◯ | X |
| CE 15 | 8.0 | 0.08 | 0.08 | 0.07 | 80 | 1.0 × 10⁶ | 90 | 0.8 × 10⁶ | 450 | 1.0 × 10 | 500 | 0.8 × 10 | 1.1 | 730 | ◯ | ◯ | X |
| CE 16 | 8.0 | 0.08 | 0.08 | 0.07 | 80 | 1.0 × 10³ | 90 | 0.9 × 10³ | 500 | 1.0 × 10² | 600 | 0.9 × 10² | 2.5 | 680 | ◯ | ◯ | X |
| CE 17 | 8.0 | 0.08 | 0.08 | 0.07 | 70 | 1.0 × 10⁶ | 80 | 0.9 × 10⁶ | 500 | 1.0 × 10 | 600 | 0.9 × 10 | 1.5 | 710 | ◯ | ◯ | X |
| CE 18 | 10.0 | 0.08 | 0.08 | 0.07 | 80 | 1.0 × 10³ | 90 | 0.9 × 10³ | 500 | 1.0 × 10² | 600 | 0.9 × 10² | 2.5 | 750 | ◯ | ◯ | X |
| CE 19 | 10.0 | 0.08 | 0.08 | 0.07 | 70 | 1.0 × 10⁶ | 80 | 0.9 × 10⁶ | 500 | 1.0 × 10 | 600 | 1.0 × 10 | 1.5 | 775 | ◯ | ◯ | X |

As shown in Table 6, Comparative examples 13 and 14 were comparative test examples in which the homogenization heat treatment was conducted at temperature 700° C. for one hour. In the homogenization treatment conducted under such conditions, the compound Y was not sufficiently formed, and as a result, the punching property was poor. Comparative examples 15 to 19 were comparative test examples in which the homogenization treatment was conducted at temperature 800° C. for one hour. In the homogenization treatment conducted under such conditions, the compound Y was not sufficiently formed (the compound was not present as compound Y, and compound X or smaller compounds increased in amount), and the density (distribution) of the compound Y decreased, which resulted in poor punching property. It is believed that in those Comparative examples 13 to 14 and Comparative examples 15 to 19, since the density of the compound Y was too low, the density of the compound Y which was brought into contact with the punch for punching and should serve as the starting point of cracks, was decreased, and the resultant punching property was poor.

Having described our invention as related to the present embodiments, it is our intention that the invention not be limited by any of the details of the description, unless otherwise specified, but rather be construed broadly within its spirit and scope as set out in the accompanying claims.

This non-provisional application claims priority under 35 U.S.C. §119 (a) on Patent Application No. 2008-324792 filed in Japan on Dec. 19, 2008, which is entirely herein incorporated by reference.

1. A copper alloy material for electric/electronic parts, comprising: Sn 3.0 to 13.0 mass %, any one or both of Fe and Ni 0.01 to 2.0 mass % in total, and P 0.01 to 1.0 mass %, with the balance being Cu and unavoidable impurities,
wherein an average diameter of grains is 1.0 to 5.0 μm,
wherein a compound X having an average diameter of 30 nm or more and 300 nm or less is dispersed in a density of 10⁴ to 10⁸ per mm²,
wherein a compound Y having an average diameter of more than 0.3 μm and not more than 5.0 μm is dispersed in a density of 10² to 10⁶ per mm²; and
wherein a tensile strength is 600 MPa or more.

2. The copper alloy material for electric/electronic parts according to claim 1, wherein an average value of the average diameter of the compound X is 50 nm or more and 200 nm or less.

3. The copper alloy material for electric/electronic parts according to claim 1, wherein an average value of the average diameter of the compound Y is 0.5 μm or more and 3.0 μm or less.

4. The copper alloy material for electric/electronic parts according to claim 1, wherein the compound Y has a ratio expressed by: {(the density of compound Y in a region up to 10% in thickness from a surface layer)/(the density of compound Y in a region from 40% to 60% in thickness from the surface layer)}, within a range of 0.8 to 1.0.

5. A copper alloy material for electric/electronic parts, comprising: Sn 3.0 to 13.0 mass %, any one or both of Fe and Ni 0.01 to 2.0 mass % in total, at least one of Co, Cr, and Mn 0.01 to 1.0 mass % in total, and P 0.01 to 1.0 mass %, with the balance being Cu and unavoidable impurities,
wherein an average diameter of grains is 1.0 to 5.0 μm,
wherein a compound X having an average diameter of 30 nm or more and 300 nm or less is dispersed in a density of 10⁴ to 10⁸ per mm²,
wherein a compound Y having an average diameter of more than 0.3 μm and not more than 5.0 μm is dispersed in a density of 10² to 10⁶ per mm²; and
wherein a tensile strength is 600 MPa or more.

6. The copper alloy material for electric/electronic parts according to claim 5, wherein an average value of the average diameter of the compound X is 50 nm or more and 200 nm or less.

7. The copper alloy material for electric/electronic parts according to claim 5, wherein an average value of the average diameter of the compound Y is 0.5 μm or more and 3.0 μm or less.

8. The copper alloy material for electric/electronic parts according to claim 5, wherein the compound Y has a ratio expressed by: {(the density of compound Y in a region up to 10% in thickness from a surface layer)/(the density of compound Y in a region from 40% to 60% in thickness from the surface layer)}, within a range of 0.8 to 1.0.

9. A method of producing the copper alloy material for electric/electronic parts according to claim 1, comprising: subjecting an ingot to a homogenization treatment, with the ingot having been produced under the conditions in which a cooling speed at the time of casting is higher than 1° C./sec and lower than 100° C./sec; face milling of the surface in a thickness of 1 mm or more; repeating cold rolling and intermediate annealing; and conducting finish rolling and strain relief annealing.

10. The method of producing the copper alloy material for electric/electronic parts according to claim 9, wherein a final intermediate annealing immediately before the finish rolling is conducted at 300 to 550° C.

11. The method of producing the copper alloy material for electric/electronic parts according to claim 9, wherein an average value of the average diameter of the compound X is 50 nm or more and 200 nm or less.

12. The method of producing the copper alloy material for electric/electronic parts according to claim 9, wherein an average value of the average diameter of the compound Y is 0.5 μm or more and 3.0 μm or less.

13. The method of producing the copper alloy material for electric/electronic parts according to claim 9, wherein the compound Y has a ratio expressed by: {(the density of compound Y in a region up to 10% in thickness from a surface layer)/(the density of compound Y in a region from 40% to 60% in thickness from the surface layer)}, within a range of 0.8 to 1.0.

14. A method of producing the copper alloy material for electric/electronic parts according to claim 5, comprising: subjecting an ingot to a homogenization treatment, with the ingot having been produced under the conditions in which a cooling speed at the time of casting is higher than 1° C./sec and lower than 100° C./sec; face milling of the surface in a thickness of 1 mm or more; repeating cold rolling and intermediate annealing; and conducting finish rolling and strain relief annealing.

15. The method of producing the copper alloy material for electric/electronic parts according to claim 14, wherein a final intermediate annealing immediately before the finish rolling is conducted at 300 to 550° C.

16. The method of producing the copper alloy material for electric/electronic parts according to claim 14, wherein an average value of the average diameter of the compound X is 50 nm or more and 200 nm or less.

17. The method of producing the copper alloy material for electric/electronic parts according to claim 14, wherein an average value of the average diameter of the compound Y is 0.5 μm or more and 3.0 μm or less.

18. The method of producing the copper alloy material for electric/electronic parts according to claim 14, wherein the compound Y has a ratio expressed by: {(the density of compound Y in a region up to 10% in thickness from a surface layer)/(the density of compound Y in a region from 40% to 60% in thickness from the surface layer)}, within a range of 0.8 to 1.0.
